(19) United States
(12) Patent Application Publication
(10) Pub. No.: US 2012/0006912 A1
(43) Pub. Date: Jan. 12, 2012

(54) WATER FAUCET AND LIQUID SOAP SUPPLY ASSEMBLY THEREFOR

(76) Inventor: Chung Hin Ho, Hong Kong (HK)

(21) Appl. No.: 12/834,037

(22) Filed: Jul. 12, 2010

(51) Int. Cl. B05B 7/30

(52) U.S. Cl. 239/318

(57) ABSTRACT

A water faucet includes a faucet spout having an open end, a flow-constricting device coupled to the open end of the faucet spout. The flow-constricting device includes a first water passage, and a liquid soap passage extending from a side of the flow-constricting device to the first water passage. A liquid soap delivering tube has an inlet end coupled to a liquid soap container and an outlet end coupled to the side of the flow-constricting device. When water runs through the first water passage, venture effect is produced causing a negative pressure that draws liquid soap out of the liquid soap container, through the liquid soap delivering tube and the liquid soap passage, and into the first water passage where the liquid soap mixes with the water and produces liquid soap foam after passing a screen. Dispensing-mode converters for converting the faucet from foam dispensing mode to water dispensing mode or water jet mode are also disclosed.

The present application relates to a water faucet with a liquid soap supply assembly, and a liquid soap supply assembly for incorporation with an ordinary water faucet.

### BACKGROUND

Currently, it is necessary to manually work up a lather from a soap or a liquid soap before achieving a cleaning effect. Since soap or liquid soap is more viscous, it requires more time and effort to work up a cleansing lather for washing

### SUMMARY

According to one aspect, there is provided a water faucet including:
a faucet spout having an open end;
a flow-constricting device coupled to the open end of the faucet spout, the flow-constricting device including a first water passage, and a liquid soap passage extending from a side of the flow-constricting device to the first water passage; and
a liquid soap delivering tube having an inlet end coupled to a liquid soap container, and an outlet end coupled to the side of the flow-constricting device and in fluid communication with the liquid soap passage;
wherein when water runs through the first water passage, venturi effect causes a negative pressure that draws liquid soap out of the liquid soap container, through the liquid soap delivering tube and the liquid soap passage, and into the first water passage where the liquid soap mixes with the water and readily discharge to form liquid soap foam.

The water faucet further includes a pressure-regulating tube having a mode-converting open end opening to the atmosphere and a closed end, the pressure-regulating tube being in communication with the liquid soap delivering tube, wherein the water faucet is in a water dispensing mode when the mode-converting open end is open, and the water faucet is in a foam dispensing mode when the mode-converting open end is closed.

In one embodiment, the two ends of the pressure-regulating tube are disposed respectively at an upper side and a lower side of the faucet spout, and the mode-converting open end can be either end with the other end closed.

The water faucet further includes at least one second water passage through which water flows out of the faucet spout, a mode-converting knob movably coupled to a downstream side of the flow-constricting device, and a gasket held between the flow-constricting device and the mode-converting knob, wherein the mode-converting knob has a central opening and is movable between a tightened position where the gasket is compressed between the flow-constricting device and the mode-converting knob thereby sealing the at least one second water passage, and a loosened position where the gasket is released and spaced apart from the at least one second water passage, wherein the water faucet is in a water dispensing mode when the mode-converting knob is in the loosened position and the water faucet is in a foam dispensing mode when the mode-converting knob is in the tightened position.

The water faucet further includes at least one second water passage through which water flows out of the faucet spout, a mode-converting knob movably coupled to a downstream side of the flow-constricting device, and a gasket held between the flow-constricting device and the mode-converting knob, wherein the mode-converting knob has a central opening and is movable between a tightened position where the gasket is compressed between the flow-constricting device and the mode-converting knob thereby sealing the at least one second water passage, and a loosened position where the gasket is released and spaced apart from the at least one second water passage, wherein the water faucet is in a water dispensing mode when the mode-converting knob is in the loosened position and the mode-converting open end is open, and the water faucet is in a water jet mode when the mode-converting knob is in the tightened position and the mode-converting open end is open, and the water faucet is in a foam dispensing mode when the mode-converting knob is in the tightened position and the mode-converting open end is closed.

In one embodiment, the flow-constricting device is threadably connected to the mode-converting knob.

In one embodiment, the flow-constricting device is generally cylindrical in shape, the first water passage is formed along a central axis of the flow-constricting device, and the liquid soap passage is formed on a plane perpendicular to the central axis.

In one embodiment, the flow-constricting device is formed with external threads threadably engaged with internal threads formed inside the open end of the faucet spout.

In one embodiment, the liquid soap passage includes an annular passage defined by an annular recess formed on an outer circumflex surface of the flow-constricting device and an inner annular surface of the open end of the faucet spout against which the flow-constricting device sealingly abuts, and a plurality of radial passages defined by a plurality of bores converging centripetally from the annular passage to the first water passage.

In one embodiment, the liquid soap passage includes four radial passages arranged at a right angle to each other in the shape of a cross.

The water faucet further includes four second water passages arranged respectively at the four quadrants defined by the cross-shaped liquid soap passages formed in the flow-constricting device.

The water faucet further includes a screen disposed downstream of the flow-constricting device.

In one embodiment, the liquid soap delivering tube is provided inside the faucet spout.

The water faucet further includes a liquid soap volume adjusting device operatively coupled to the liquid soap delivering tube to adjust the amount of liquid soap flowing therethrough.

In one embodiment, the liquid soap volume adjusting device includes a screw threadably connected to an internally threaded through hole provided on the faucet spout, and the screw has an inner end abutting against the liquid soap delivering tube and adapted to partially squeeze the liquid soap delivering tube.

In one embodiment, the liquid soap container is located under a sink on which the water faucet is mounted, and a coupling tube is provided on a water pipe underneath the sink for coupling the inlet end of the liquid soap delivering tube and the liquid soap container together.

In one embodiment, the liquid soap delivering tube is made of a flexible material.

According to another aspect, there is provided a liquid soap supply assembly for incorporation with an ordinary water faucet, the assembly including:
(a) a flow-constricting device attachable to an open end of a faucet spout of the water faucet, the flow-constricting device including a first water passage, and a liquid soap passage extending from a side of the flow-constricting device to the first water passage;
(b) a liquid soap container; and
(c) a liquid soap delivering tube having an inlet end coupled to the liquid soap container, and an outlet end coupled to the side of the flow-constricting device and in fluid communication with the liquid soap passage.

Although the water faucet disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the water faucet disclosed in the present application will now be described by way of example with reference to the accompanying drawings wherein:

FIG. 1 is an illustrative diagram showing a first embodiment of a water faucet with a liquid soap supply assembly;

FIG. 2 is a perspective view of a flow-constricting device of the water faucet with a liquid soap supply assembly of FIG. 1;

FIG. 3 is a cross sectional view of a first embodiment of the flow-constricting device of FIG. 2;

FIG. 4 is an illustrative diagram showing a second embodiment of the water faucet with a liquid soap supply assembly;

FIG. 5 is an illustrative diagram showing a third embodiment of the water faucet with a liquid soap supply assembly;

FIG. 6 is a cross sectional view of a second embodiment of the flow-constricting device;

FIG. 7 is an exploded view of the flow-constricting device, and a screen and gasket assembly;

FIG. 8 is an illustrative diagram showing a fourth embodiment of the water faucet with a liquid soap supply assembly;

FIG. 9 an illustrative diagram showing the incorporation of the liquid soap supply assembly with an ordinary water faucet; and

FIG. 10 is a side view of an embodiment of the flow-constricting device of the liquid soap supply assembly of FIG. 9.

### DETAILED DESCRIPTION

Reference will now be made in detail to a preferred embodiment of the water faucet disclosed in the present application, examples of which are also provided in the following description. Exemplary embodiments of the water faucet disclosed in the present application are described in detail, although it will be apparent to those skilled in the relevant art that some features that are not particularly important to an understanding of the water faucet may not be shown for the sake of clarity.

Furthermore, it should be understood that the water faucet disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the spirit and scope of the appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

Certain terminology is used in the following description for convenience only and is not limiting. The words “upper”, “lower”, “top”, “bottom”, “vertical” or “horizontal” designate directions in the drawings to which reference is made. The terminology includes the words noted above as well as derivatives thereof and words of similar import.

### First Embodiment

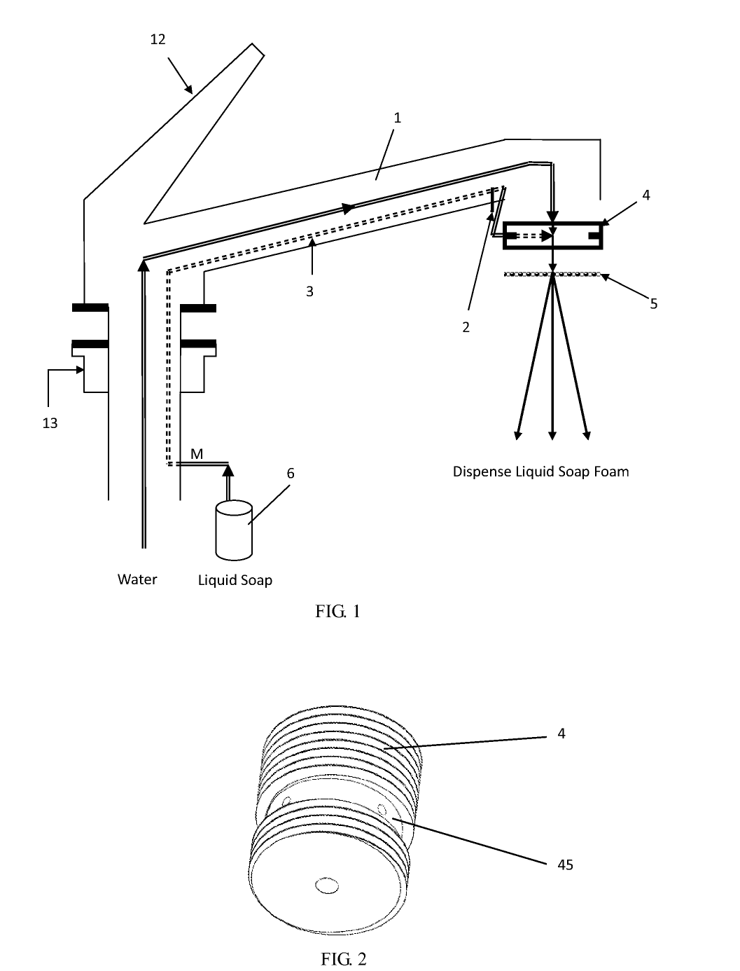

As illustrated in FIGS. 1, 2 and 3, a water faucet may include a faucet spout 1, liquid soap delivering tube 3, flow-constricting device 4, screen 5 and liquid soap container 6. The flow-constricting device 4 can be coupled to the open end of the faucet spout 1. The flow-constricting device 4 may be provided with interconnecting first water passage 41 and one or more liquid soap passages 43. The first water passage 41 is in fluid communication with the faucet spout 1 and defines a constricted path through which water can flow out from the faucet spout 1. The liquid soap passages 43 may extend from a point at circumflex side of the flow-constricting device 4 to the first water passage 41. An inlet end of the liquid soap delivering tube 3 is coupled to and in fluid communication with the liquid soap container 6. An outlet end of the liquid soap delivering tube 3 is coupled to the circumflex side of the flow-constricting device 4 and is in fluid communication with the liquid soap passages 43. The liquid soap container 6 may contain a foamable liquid soap.

When the water faucet is turned on, the water faucet is in its first dispensing mode. At this mode, water runs through the water faucet and generates a negative pressure by venturi effect that draws the liquid soap from the liquid soap container 6, through the liquid soap delivering tube 3 and into the liquid soap passages 43. The liquid soap can then mix with the water running through the first water passage 41, and dispense through the screen 5 in the form of liquid soap foam. The screen can be disposed downstream of the flow-constricting device 4. When the water faucet is turned off, no foam or water can be dispensed.

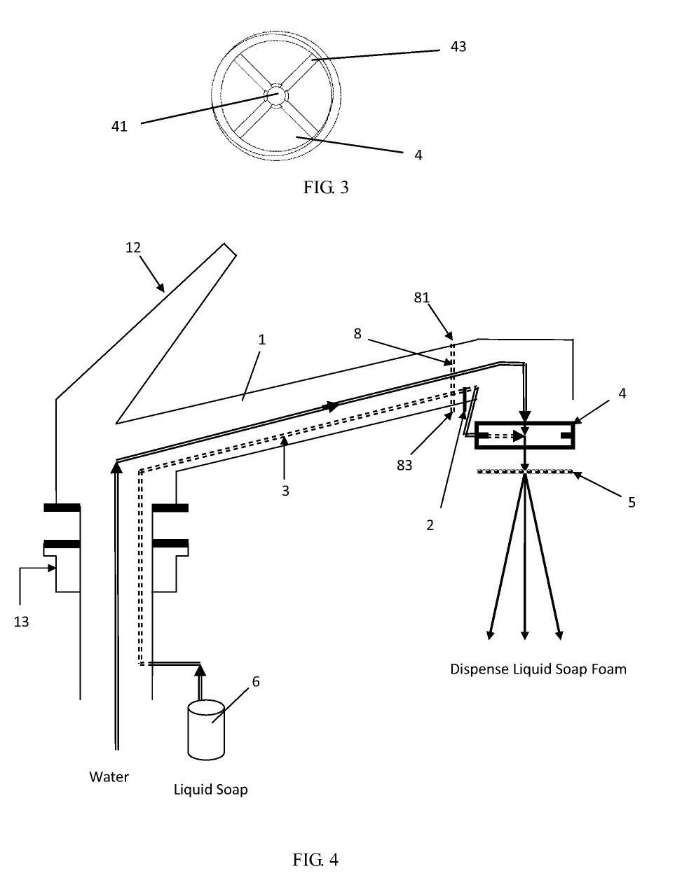

As shown in FIGS. 2 and 3, the flow-constricting device 4 may be generally cylindrical in shape. The first water passage 41 can be formed along a central axis of the flow-constricting device 4, and the liquid soap passages 43 can be formed on a plane perpendicular to the first water passage 41 at a middle portion thereof. The flow-constricting device 4 may be formed with external threads threadably engaged with internal threads formed inside the open end of the faucet spout 1.

An annular recess 45 may be formed on the flow-constricting device 4. The liquid soap passages 43 are in fluid communication with the annular recess 45. The end of the liquid soap delivering tube 3 may be directly coupled to the liquid soap passages 43. Also, the end of the liquid soap delivering tube 3 may be coupled to the liquid soap passages 43 through the annular recess 45 so that they may be in fluid communication with each other in a circumfluous manner round the recess. The liquid soap passages 43 may take the form of horizontally oriented cross-shaped passages. The flow-constricting device 4 can be detachably connected to the faucet spout 1. This can facilitate the interchanging of flow-constricting devices 4 of different dimensions to suit different water pressures.

The flow-constricting device 4 may have one or more liquid soap passages 43. For example, the flow-constricting device 4 may have only one liquid soap passage 43 defined by a single bore extending from a circumflex side of the flow-constricting device 4 to the first water passage 41. According to the illustrated embodiment, the liquid soap passage 43 may include an annular passage defined by an annular recess 45 formed on the flow-constricting device 4 and an inner annular surface of the open end of the faucet spout 1 against which the flow-constricting device 4 sealingly abuts, and a plurality of radial passages defined by a plurality of bores converging centripetally from the annular passage to the first water passage 41. According to the illustrated embodiment, the liquid soap passages 43 include four radial passages arranged at a right angle to each other and in the shape of a cross.

The liquid soap delivering tube 3 may be disposed inside the faucet spout 1. This can enhance the appearance of the water faucet. The outlet end of the liquid soap delivering tube 3 may terminate at the annular recess 45 of the flow-constricting device 4 so that liquid soap can flow from the liquid soap delivering tube 3 to the annular recess 45 and then to the radial liquid soap passages 43.

Although it has been shown and described that the outlet end of the liquid soap delivering tube 3 is coupled to a lateral side of the flow-constricting device 4, it is understood by one skilled in the art that the outlet end of the liquid soap delivering tube 3 can be coupled to a top side of the flow-constricting device 4 from which the liquid soap passage 43 extends to the first water passage 41.

Since the liquid soap passages 43 are formed into the shape of a cross, liquid soap flowing from the liquid soap delivering tube 3 and into the annular recess 45 can easily enter the liquid soap passages 43. The inlet end of the liquid soap delivering tube 3 may terminate at a coupling tube M. The coupling tube M may be provided on the surface of a vertical water pipe underneath the sink. The coupling tube M is employed to join the inlet end of the liquid soap delivering tube 3 to the liquid soap container 6 underneath the sink. The liquid soap delivering tube 3 may be made of a flexible material.

As illustrated in FIG. 1, the water faucet may be provided with a liquid soap volume adjusting device for adjusting the amount of liquid soap flowing through the liquid soap delivering tube 3 and hence the amount of foam produced. According to an embodiment, the liquid soap volume adjusting device can be in the form of an adjustment screw 2. The adjustment screw 2 may be threadably connected to an internally threaded through hole provided on the faucet spout 1. The adjustment screw 2 may have an inner end abutting against the liquid soap delivering tube 3 and adapted to partially squeeze the liquid soap delivering tube 3. The adjustment screw 2 can be adjusted so that the inner end can accordingly squeeze the liquid soap delivering tube 3, or release and restore the liquid soap delivering tube 3 to its original shape.

When the adjustment screw 2 is adjusted, the liquid soap delivering tube 3 at the position of the adjustment screw 2 can be squeezed or released. When the liquid soap delivering tube 3 is squeezed, the amount of liquid soap flowing into the flow-constricting device 4 will be reduced and the foam produced will also be reduced. When the liquid soap delivering tube 3 is not squeezed, the amount of liquid soap flowing into the flow-constricting device 4 will be at maximum and the foam produced will also be at maximum. This can accommodate different water pressures and suit different user's preference. The outer end of the adjustment screw 2 can extend outside the faucet spout to facilitate ease of operation.

Although it has been shown and described that the liquid soap volume adjusting device is in the form of an adjustment screw 2, it is appreciated by one skilled in the art that the liquid soap volume adjusting device can be in any other possible forms such as an adjustable rod.

The water faucet can be turned on and off manually by a handle 12. Of course, the water faucet can also be turned on and off by other means such as a sensor-controlled valve. The water faucet can be fixedly attached to a sink by nut 13. The water faucet can operate without the screen 5. Without the screen 5, the liquid soap mixes with water and can dispense directly from the flow-constricting device 4 in the form of diluted liquid soap. The employment of the screen 5 can turn the dispensing of diluted liquid soap into foam easier.

The principle of operation of the water faucet is described below. When the water faucet is turned off, nothing flows out from the faucet spout 1. When the water faucet is turned on, water flows from a water pipe to the faucet spout 1 and then flows out of the faucet spout 1 through the first water passage 41 of the flow-constricting device 4. When water flows through the first water passage 41, negative pressure so generated by venture effect can draw liquid soap out of the liquid soap container 6, through the liquid soap delivering tube 3, into the annular recess 45, and then into the liquid soap passages 43. Since the liquid soap passages 43 and the first water passage 41 are in fluid communication, the liquid soap can mix with the water, form into liquid soap foam after passing through the screen 5. A user can control the amount (or strength) of the foam by using the adjustment screw 2. Applying the theory of venturi tube, the flow-constricting device 4 triggers a reduction in pressure thereby drawing the liquid soap out of the liquid soap container 6, through the liquid soap delivering tube 3, and into the flow-constricting device 4 where the liquid soap mixes with water and produces a large amount of liquid soap foam through the screen 5.

### Second Embodiment

As illustrated in FIG. 4, the water faucet may include a dispensing-mode converter to control the conversion between a first dispensing mode and a second dispensing mode. In the first dispensing mode, the water faucet dispenses foam. In the second dispensing mode, the water faucet dispenses water. According to the illustrated embodiment, the dispensing-mode converter is in the form of a pressure-regulating tube 8 which is in communication with the liquid soap delivering tube 3. The pressure-regulating tube 8 may have a first end 81 that is closed and a second mode-converting open end 83 that is open and in communication with the outside atmosphere. It is understood that the first end 81 can be a mode-converting open end instead and the second end 83 can be a closed end. The first end 81 may extend to an upper side of the faucet spout 1, and the second end 83 may extend to a lower side of the faucet spout 1.

The water faucet is in a water dispensing mode when the mode-converting open end 81 or 83 of the pressure-regulating tube 8 is open, and the water faucet is in a foam dispensing mode when the mode-converting open end 81 or 83 of the pressure-regulating tube 8 is covered and closed. The dimension of the cross section of the pressure-regulating tube 8 may be larger than the dimension of the cross section of the liquid soap delivering tube 3. This can quickly balance the change in pressure due to water flow by simply opening or closing the mode-converting open end of the pressure-regulating tube 8.

The principle of operation of the second embodiment of the water faucet is described below. When the water faucet is turned off, nothing flows out from the faucet spout 1. When the water faucet is turned on and the mode-converting open end of the pressure-regulating tube 8 is closed, for example by covering the mode-converting open end with a finger, water flows from a water pipe to the faucet spout 1, and then flows out of the faucet spout 1 through the first water passage 41 of the flow-constricting device 4. When water flows through the first water passage 41, negative pressure so generated by venture effect can draw liquid soap out of the liquid soap container 6, through the liquid soap delivering tube 3, into the annular recess 45, and then into the liquid soap passages 43. Since the liquid soap passages 43 and the first water passage 41 are in fluid communication, the liquid soap can mix with the water running through the first water passage 41, form into liquid soap foam after passing through the screen 5.

When the water faucet is turned on and the mode-converting open end of the pressure-regulating tube 8 is open, water flows from a water pipe to the faucet spout 1 and then flows out of the faucet spout 1 through the first water passage 41 of the flow-constricting device 4. At this moment, the liquid soap delivering tube 3 is in communication with the outside atmosphere through the pressure-regulating tube 8. The negative pressure generated by the water flow is balanced by the atmosphere at the mode-converting open end of the pressure-regulating tube 8 and therefore no liquid soap can be drawn out. Hence, the water faucet can only dispense water.

### Third Embodiment

As illustrated in FIGS. 5, 6 and 7, the water faucet may include a further dispensing-mode converter. The dispensing-mode converter can control the conversion of the water faucet between a first dispensing mode and a second dispensing mode. In the first dispensing mode, the water faucet dispenses liquid soap foam. In the second dispensing mode, the water faucet dispenses water. According to the present embodiment, the flow-constricting device 4 may also include one or more second water passages 42.

The dispensing-mode converter may include a mode-converting knob 7 and a gasket 9. The gasket 9 may be annular in shape. The gasket 9 can be held between the flow-constricting device 4 and the mode-converting knob 7. The mode-converting knob 7 may be annular in shape and has a central opening through which foam or water flows out. The mode-converting knob 7 may have an integral annular platform for holding the gasket 9 and the screen 5. The screen 5 may be held between the gasket 9 and the mode-converting knob 7. The mode-converting knob 7 can be movably connected to a downstream end of the flow-constricting device 4. The mode-converting knob 7 can be connected to the flow-constricting device 4 through thread connection.

Although it has been shown and described that the mode-converting knob 7 is connected to the flow-constricting device 4 through thread connection. It is contemplated by one skilled in the art that the mode-converting knob 7 can be connected to the flow-constricting device 4 by any possible fasteners. For example, the gasket can be compressed against the flow-constricting device 4 by means of a spring and the mode-converting knob 7 can be connected to the flow-constricting device by appropriate fastening means such as hooks and catches etc.

The mode-converting knob 7 is adapted to be movable from a tightened position where the gasket 9 is compressed between the flow-constricting device 4 and the mode-converting knob 7 thereby sealing the second water passages 42, and a loosened position where the gasket 9 is released and spaced apart from the second water passages 42. The water faucet is in a water dispensing mode when the mode-converting knob 7 is in the loosened position, and the water faucet is in a foam dispensing mode when the mode-converting knob 7 is in the tightened position.

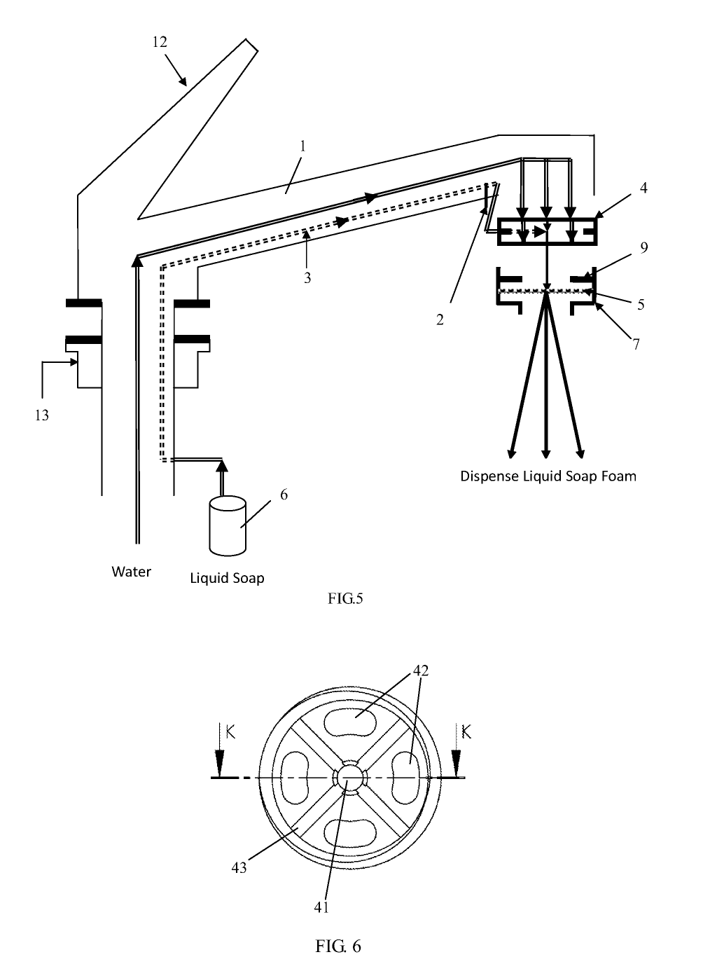

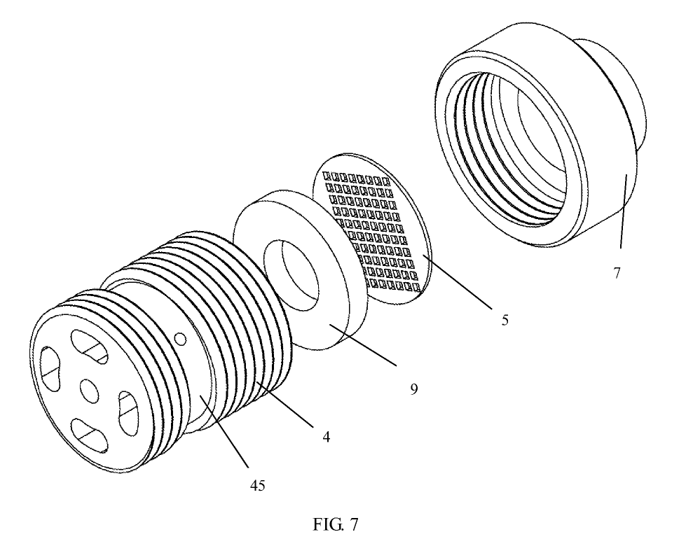

According to the embodiment illustrated in FIGS. 6 and 7, there is one vertical first water passage 41 extending along the central axis of the flow-constricting device 4, and four vertical second water passages 42 disposed around the first water passage 41.

The four second water passages 42 can be arranged respectively at the four quadrants defined by the cross-shaped liquid soap passages 43 formed in the flow-constricting device 4.

As depicted in the cross sectional view in FIG. 6, the four second water passages 42 are located at the east, south, west and north sides of the first water passage 41 respectively. The four liquid soap passages 43 are horizontally disposed in the shape of a cross on a plane perpendicular to water passages 41 and 42; and extending radially in the north-east, south-east, south-west and north-west directions respectively until terminated at the annular recess 45.

The principle of operation of the third embodiment of the water faucet is described below. When the water faucet is turned off, nothing flows out from the faucet spout 1. When the water faucet is turned on and the mode-converting knob 7 is tightened, the gasket 9 seals the second water passages 42 but not the first water passage 41. Water flows from a water pipe to the faucet spout 1, and then flows out of the faucet spout 1 through the first water passage 41 of the flow-constricting device 4. When water flows through the first water passage 41, negative pressure so generated by venture effect can draw liquid soap out of the liquid soap container 6, through the liquid soap delivering tube 3, into the annular recess 45, and then into the liquid soap passages 43. Since the liquid soap passage 43 and the first water passage 41 are in fluid communication, the liquid soap can mix with the water running through the first water passage 41, form into liquid soap foam after passing through the screen 5. A user can also turn the adjustment screw 2 to adjust the amount (or strength) of dispensing foam if desired.

When the water faucet is turned on and the mode-converting knob 7 is loosened, gasket 9 does not cover both the first water passages 41 and the second water passages 42. Water flows from the water pipe to the faucet spout 1 and flows out of the faucet spout 1 through the first water passage 41 and the second water passages 42 of the flow-constricting device 4. When the water is flowing out, there is not enough reduction in pressure sufficiently to draw the liquid soap from the liquid soap container 6, through the liquid soap delivering tube 3 and into the annular recess 45 and liquid soap passages 43 of the flow-constricting device 4. Hence, the water faucet can only dispense water.

### Fourth Embodiment

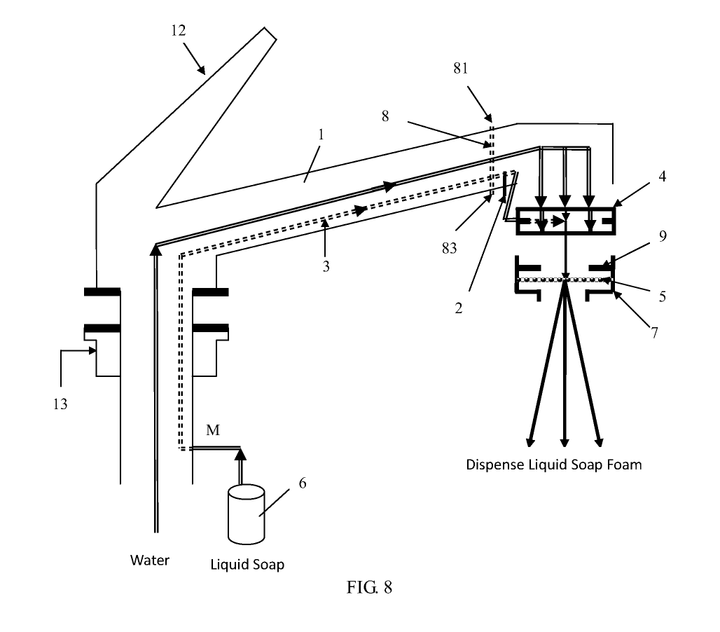

As illustrated in FIGS. 6, 7 and 8, the fourth embodiment is a combination of the second and third embodiments. The water faucet of the present embodiment may include a dispensing-mode converter. The dispensing-mode converter can control the conversion of the water faucet between a first dispensing mode and a second dispensing mode. In the first dispensing mode, the water faucet dispenses liquid soap foam. In the second dispensing mode, the water faucet dispenses water. In the second dispensing mode, the user can further choose the dispensing of water of regular flow rate or high speed water jet.

According to the illustrated embodiment, the dispensing-mode converter may include a pressure-regulating tube 8 which is in communication with the liquid soap delivering tube 3. The pressure-regulating tube 8 may have a first end 81 that is closed and a second mode-converting open end 83 that is open and in communication with the outside atmosphere. It is understood that the first end 81 can be an open end and the second end 83 can be a closed end instead. The first end 81 may extend to an upper side of the faucet spout 1, and the second end 83 may extend to a lower side of the faucet spout 1. According to the present embodiment, the flow-constricting device 4 may also include second water passages 42. The dispensing-mode converter may include a mode-converting knob 7 and a gasket 9. The mode-converting knob 7 can be detachably connected to a downstream end of the flow-constricting device 4. The gasket 9 can be held between the flow-constricting device 4 and the mode-converting knob 7.

The mode-converting knob 7 is adapted to be movable from a tightened position where the gasket 9 is compressed between the flow-constricting device 4 and the mode-converting knob 7 thereby sealing the second water passage 42, and a loosened position where the gasket 9 is released and spaced apart from the second water passages 42. The water faucet is in a water dispensing mode when the mode-converting knob 7 is in the loosened position and the open end of the pressure-regulating tube 8 is open, and the water faucet is in a water jet mode when the mode-converting knob 7 is in the tightened position and the mode-converting open end of the pressure-regulating tube 8 is open, and the water faucet is in a foam dispensing mode when the mode-converting knob 7 is in the tightened position and the mode-converting open end of the pressure-regulating tube 8 is closed.

The principle of operation of the fourth embodiment of the water faucet is described below. When the water faucet is turned off, nothing flows out from the faucet spout 1. When the water faucet is turned on and the mode-converting knob 7 is loosened and the mode-converting open end of the pressure-regulating tube 8 is open, annular gasket 9 does not seal the first and second water passages 41, 42. When the water is flowing out, the negative pressure so generated, whether sufficient or not, will be balanced by the atmosphere at the mode-converting open end of the pressure-regulating tube 8. Therefore, no liquid soap can be drawn from the liquid soap container 6, through the liquid soap delivering tube 3 and into the annular recess 45 and liquid soap passages 43 of the flow-constricting device 4. Hence, the faucet can only dispense water.

When the water faucet is turned on and the mode-converting knob 7 is tightened and the mode-converting open end of the pressure-regulating tube 8 is open, the gasket 9 seals the second water passages 42 but not the first water passage 41. Water flows from a water pipe to the faucet spout 1, and then flows out of the faucet spout 1 through the first water passage 41 of the flow-constricting device 4. At this moment, the liquid soap delivering tube 3 is in communication with the atmosphere through the mode-converting open end of the pressure-regulating tube 8. The negative pressure generated by the water flow will be balanced by the atmosphere at the mode-converting open end of the pressure-regulating tube 8 and no liquid soap can be drawn out of the liquid soap container 6. Hence, the faucet produces a high speed water jet.

When the water faucet is turned on and the mode-converting knob 7 is tightened and the mode-converting open end of the pressure-regulating tube 8 is covered, for example by a finger, the gasket 9 seals the second water passages 42 but not the first water passage 41. Water flows from the water pipe to the faucet spout 1, and flows out of the faucet spout 1 through the first water passage 41 of the flow-constricting device 4. When water flows through the first water passage 41, negative pressure so generated by venture effect can draw liquid soap out of the liquid soap container 6, through the liquid soap delivering tube 3, into the annular recess 45, and then into the liquid soap passages 43. Since the liquid soap passage 43 and the first water passage 41 are in fluid communication, the liquid soap can mix with the water running through the first water passage 41, form into liquid soap foam after passing through the screen 5. A user can also turn the adjustment screw 2 to adjust the amount (or strength) of the dispensing foam.

The water faucet of the present embodiment can generate different functions and can produce three dispensing effects, namely water of a normal flow rate, liquid soap foam and high speed water jet.

### Fifth Embodiment

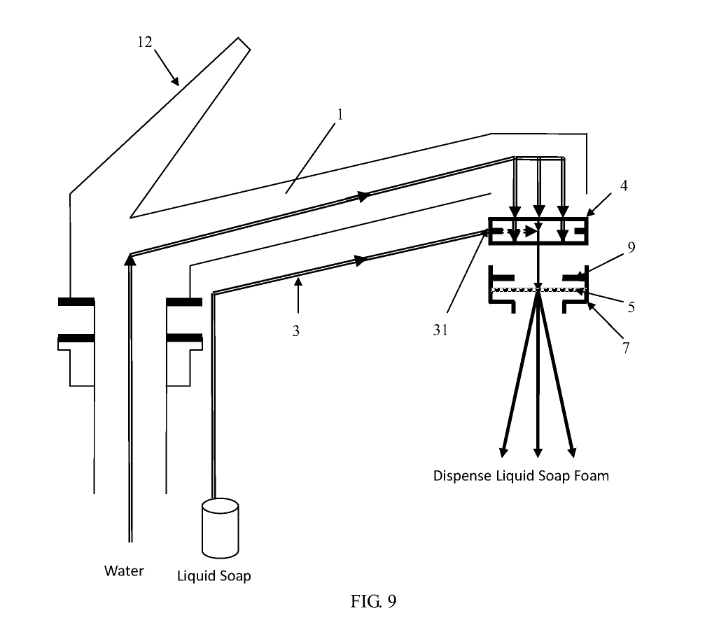

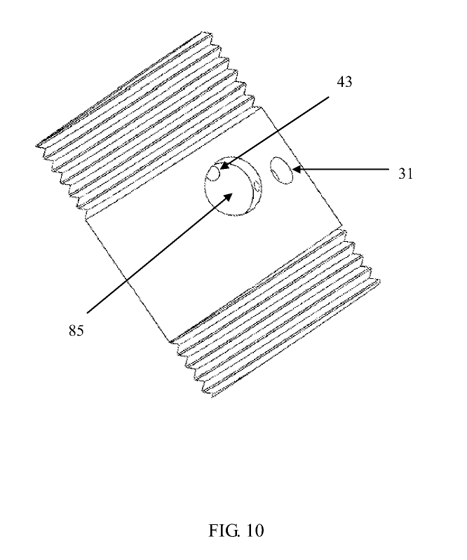

As illustrated in FIGS. 9 and 10, there is provided a liquid soap supply assembly for incorporation with an ordinary water faucet. The liquid soap supply assembly may include a liquid soap delivering tube 3, flow-constricting device 4, dispensing-mode converter and screen 5. The liquid soap delivering tube 3 is disposed outside the faucet spout 1.

The flow-constricting device 4 can be coupled to the open end of the faucet spout 1. The flow-constricting device 4 may be provided with interconnecting liquid soap passages 43 and first water passage 41. The first water passage 41 is in fluid communication with the faucet spout 1. The outlet end of the liquid soap delivering tube 3 may be coupled to a circular tube-coupling recess 31 provided on an outer surface of the flow-constricting device 4. The tube-coupling recess 31 is in fluid communication with a mode-converting recess 85 through a through bore. The mode-converting recess 85 is in turn in fluid communication with the liquid soap passages 43. Of course, it is understood that the flow-constricting device 4 may not be provided with the tube-coupling recess 31. The liquid soap delivering tube 3 can be in fluid communication with the liquid soap passages 43 directly through the mode-converting recess 85. In use, the inlet end of the liquid soap delivering tube 3 is coupled to a liquid soap container 6. The liquid soap container 6 may contain a foamable liquid soap.

The dispensing-mode converter can control the conversion of the water faucet between a first dispensing mode and a second dispensing mode. In the second dispensing mode, when the mode-converting knob 7 is loosened and the mode-converting recess 85 is open, water from the faucet spout 1 can flow out through the flow-constricting device 4 and the screen 5. In the first dispensing mode, when the mode-converting knob 7 is tightened and the mode-converting recess 85 is covered by a finger, the liquid soap delivering tube 3 delivers liquid soap from the liquid soap container 6 to the tube-coupling recess 31 of the flow-constricting device 4, and then to the liquid soap passage 43 through the mode-converting recess 85. The liquid soap then mixes with the water running through the first water passage 41, forms liquid soap foam, after passing out through the screen 5.

As depicted in FIGS. 6 and 10, the flow-constricting device 4 may include at least one second water passage 42. The first water passage 41 may include a central vertical water passage provided at the center of the flow-constricting device 4. The at least one second water passage 42 may include four vertical water passages formed around the central first water passage 41.

As shown in FIGS. 9 and 10, the flow-constricting device 4 may include a mode-converting knob 7 and a gasket 9. The gasket 9 is located between the flow-constricting device 4 and the mode-converting knob 7. When the mode-converting knob 7 is tightened, the gasket 9 can seal the second water passages 42 but not the first water passage 41. When the mode-converting knob 7 is loosened, the gasket 9 does not seal the second water passages 42.

According to the present embodiment, the detachable flow-constricting device 4, mode-converting knob 7, annular gasket 9 and screen 5 can be developed independently. Together with the externally disposed liquid soap delivering tube 3, the liquid soap supply assembly can be installed and used in association with an existing ordinary water faucet. The present embodiment is low in manufacturing cost, low in price and save the process of installing a new water faucet.

According to the embodiments disclosed in the present application, the water faucet can dispense liquid soap foam directly. The workability of the foam can enhance the working effect and cleaning capacity. The use of foam can reduce the consumption of liquid soap during each cleaning process. The use of foam can also make cleaning an interesting process. Since the viscosity of foam is less than soap or liquid soap, the foam can be spread and washed away easily. Hence, this can reduce the consumption of water and save the water supply.

The liquid soap container 6 can be placed under the sink instead of putting above. This can provide extra space over the sink, and make the setup neat, simple and elegant. A high hygiene standard and tidiness is therefore maintained by elimination of soap or liquid soap residue left over after every use.

The liquid soap container 6 can be a large container and the liquid soap can be supplied in bulk to reduce wastes disposal. Furthermore, the viscosity of the naturally formed foam has the same function as the conditioning agent in liquid soap. This can reduce the dosage of the conditioning agent in liquid soap production and hence decrease the manufacturing cost. The water faucet disclosed in the present application can make cleansing and bathing easy, interesting and environmental friendly.

In practical use, foam can be sprayed onto a user's hand for personal hygiene or sprayed onto clothes for clothes washing, or sprayed into a bath tub for foam bathing. When foaming is not required, the user can discontinue the foam discharge as wished and the water faucet can resume back to an ordinary water faucet for dispensing only water.

While the water faucet disclosed in the present application has been shown and described with particular references to a number of preferred embodiments thereof, it should be noted that various other changes or modifications may be made without departing from the scope of the appending claims.

What is claimed is:

1. A water faucet comprising:
a faucet spout having an open end;
a flow-constricting device coupled to the open end of the faucet spout, the flow-constricting device comprising a first water passage, and a liquid soap passage extending from a side of the flow-constricting device to the first water passage; and
a liquid soap delivering tube having an inlet end coupled to a liquid soap container, and an outlet end coupled to the side of the flow-constricting device and in fluid communication with the liquid soap passage;
wherein when water runs through the first water passage, venturi effect causes a negative pressure that draws liquid soap out of the liquid soap container, through the liquid soap delivering tube and the liquid soap passage, and into the first water passage where the liquid soap mixes with the water and readily discharge to form liquid soap foam.

2. The water faucet as claimed in claim 1, further comprising a pressure-regulating tube having a mode-converting open end opening to the atmosphere and a closed end, the pressure-regulating tube being in communication with the liquid soap delivering tube, wherein the water faucet is in a water dispensing mode when the mode-converting open end is open, and the water faucet is in a foam dispensing mode when the mode-converting open end is closed.

3. The water faucet as claimed in claim 2, wherein the two ends of the pressure-regulating tube are disposed respectively at an upper side and a lower side of the faucet spout, and the mode-converting open end can be either end with the other end closed.

4. The water faucet as claimed in claim 1, further comprising at least one second water passage through which water flows out of the faucet spout, a mode-converting knob movably coupled to a downstream side of the flow-constricting device, and a gasket held between the flow-constricting device and the mode-converting knob, wherein the mode-converting knob has a central opening and is movable between a tightened position where the gasket is compressed between the flow-constricting device and the mode-converting knob thereby sealing the at least one second water passage, and a loosened position where the gasket is released and spaced apart from the at least one second water passage, wherein the water faucet is in a water dispensing mode when the mode-converting knob is in the loosened position and the water faucet is in a foam dispensing mode when the mode-converting knob is in the tightened position.

5. The water faucet as claimed in claim 2, further comprising at least one second water passage through which water flows out of the faucet spout, a mode-converting knob movably coupled to a downstream side of the flow-constricting device, and a gasket held between the flow-constricting device and the mode-converting knob, wherein the mode-converting knob has a central opening and is movable between a tightened position where the gasket is compressed between the flow-constricting device and the mode-converting knob thereby sealing the at least one second water passage, and a loosened position where the gasket is released and spaced apart from the at least one second water passage, wherein the water faucet is in a water dispensing mode when the mode-converting knob is in the loosened position and the mode-converting open end is open, and the water faucet is in a water jet mode when the mode-converting knob is in the tightened position and the mode-converting open end is open, and the water faucet is in a foam dispensing mode when the mode-converting knob is in the tightened position and the mode-converting open end is closed.

6. The water faucet as claimed in claim 5, wherein the flow-constricting device is threadably connected to the mode-converting knob.

7. The water faucet as claimed in claim 1, wherein the flow-constricting device is generally cylindrical in shape, the first water passage is formed along a central axis of the flow-constricting device, and the liquid soap passage is formed on a plane perpendicular to the central axis.

8. The water faucet as claimed in claim 1, wherein the flow-constricting device is formed with external threads threadably engaged with internal threads formed inside the open end of the faucet spout.

9. The water faucet as claimed in claim 1, wherein the liquid soap passage comprises an annular passage defined by an annular recess formed on an outer circumflex surface of the flow-constricting device and an inner annular surface of the open end of the faucet spout against which the flow-constricting device sealingly abuts, and a plurality of radial passages defined by a plurality of bores converging centripetally from the annular passage to the first water passage.

10. The water faucet as claimed in claim 9, wherein the liquid soap passage comprises four radial passages arranged at a right angle to each other in the shape of a cross.

11. The water faucet as claimed in claim 10, further comprising four second water passages arranged respectively at the four quadrants defined by the cross-shaped liquid soap passages formed in the flow-constricting device.

12. The water faucet as claimed in claim 1, further comprising a screen disposed downstream of the flow-constricting device.

13. The water faucet as claimed in claim 1, wherein the liquid soap delivering tube is provided inside the faucet spout.

14. The water faucet as claimed in claim 1, further comprising a liquid soap volume adjusting device operatively coupled to the liquid soap delivering tube to adjust the amount of liquid soap flowing therethrough.

15. The water faucet as claimed in claim 14, wherein the liquid soap volume adjusting device comprises a screw threadably connected to an internally threaded through hole provided on the faucet spout, and the screw has an inner end abutting against the liquid soap delivering tube and adapted to partially squeeze the liquid soap delivering tube.

16. The water faucet as claimed in claim 1, wherein the liquid soap container is located under a sink on which the water faucet is mounted, and a coupling tube is provided on a water pipe underneath the sink for coupling the inlet end of the liquid soap delivering tube and the liquid soap container together.

17. A liquid soap supply assembly for incorporation with an ordinary water faucet, the assembly comprising:
a flow-constricting device attachable to an open end of a faucet spout of the water faucet, the flow-constricting device comprising a first water passage, and a liquid soap passage extending from a side of the flow-constricting device to the first water passage;
a liquid soap container; and
a liquid soap delivering tube having an inlet end coupled to the liquid soap container, and an outlet end coupled to the side of the flow-constricting device and in fluid communication with the liquid soap passage.

18. The liquid soap supply assembly as claimed in claim 17, further comprising at least one second water passage through which water flows out of the faucet spout, a mode-converting knob movably coupled to the flow-constricting device, and a gasket provided between the flow-constricting device and the mode-converting knob; wherein the mode-converting knob has a central opening and is movable between a tightened position where the gasket is compressed between the flow-constricting device and the mode-converting knob thereby sealing the at least one second water passage, and a loosened position where the gasket is released and spaced apart from the at least one second water passage.

19. The liquid soap supply assembly as claimed in claim 18, comprising four second water passages arranged around the first water passage.

20. The liquid soap supply assembly as claimed in claim 18, wherein the outer surface of the flow-constricting device is provided with a mode-converting recess, and the outlet end of the liquid soap delivering tube is in fluid communication with the mode-converting recess, wherein the water faucet is in a water dispensing mode when the mode-converting knob is in the loosened position and the mode-converting recess is open, and the water faucet is in a foam dispensing mode when the mode-converting knob is in the tightened position and the mode-converting recess is closed.

21. The liquid soap supply assembly as claimed in claim 20, further comprising a tube-coupling recess formed on an outer surface of the flow-constricting device for coupling with the outlet end of the liquid soap delivering tube, the tube-coupling recess being in fluid communication with the mode-converting recess through a through hole.

22. The liquid soap supply assembly as claimed in claim 17, wherein the flow-constricting device is generally cylindrical in shape

23. The liquid soap supply assembly as claimed in claim 17, wherein the first water passage is formed along a central axis of the flow-constricting device, and the liquid soap passage is formed on a plane perpendicular to the central axis.

24. The liquid soap supply assembly as claimed in claim 17, wherein the flow-constricting device is formed with external threads threadably engaged with internal threads formed inside the open end of the faucet spout.

25. The liquid soap supply assembly as claimed in claim 17, further comprising a screen disposed downstream of the flow-constricting device.

26. The liquid soap supply assembly as claimed in claim 17, wherein the liquid soap delivering tube is provided outside the faucet spout.

27. The liquid soap supply assembly as claimed in claim 17, wherein the liquid soap delivering tube is made of a flexible material.
